(19) United States
(12) Patent Application Publication
(10) Pub. No.: US 2008/0257267 A1
(43) Pub. Date: Oct. 23, 2008

(54) Stall Arrangement and Installation for Dairy Cattle Farming

(76) Inventors: Uwe Osthues, Mende-Bosperde (DE); Michael Schomaker, Oelde (DE)

Correspondence Address: Jeffry W. Smith;SMITH LAW OFFICE, 440 Science Drive, Suite 302, Madison, WI, 53711, US

(21) Appl. No.: 10/592,907

(22) PCT Filed: Mar. 18, 2005
(86) PCT No.: PCT/EP2005/002930

§ 371 Date: Jun. 26, 2008

(30) Foreign Application Priority Data
Mar. 23, 2004 (DE) 102004014520.2

(51) Int. Cl. A01K 1/12; A01K 1/00

(52) U.S. Cl. 119/14.04; 119/14.03; 119/14.08; 119/51.01

(57) ABSTRACT

The cowshed installation comprises a milking area and a circular cowshed comprising a center area and a substantially concentric surrounding loafing area. The milking area is located radially outwardly of the loafing area.

### FIELD AND BACKGROUND OF THE INVENTION

The object of the patent application relates to a cowshed arrangement and a cowshed installation for dairy cattle husbandry. Although the invention will be described below substantially with reference to cows, employment of the invention is not limited to be applied with cows but it is viable as well for other lactating animals such as sheep, goats, buffaloes, llamas, camels, yaks, dromedaries and reindeer, etc.

Different cowshed concepts have been developed for dairy cattle husbandry. The type of cowshed chosen for large dairy cattle herds tends to be an open shed. The fundamental advantages of an open shed are operating efficiency and keeping conditions suitable for the animals. The dairy cattle, which may be cows, is free to move about an open shed. This allows to subdivide the shed into multiple areas adapted to the requirements of humans and animals.

Within a cowshed arrangement, resting areas are frequently provided for the animals. The resting areas may be formed of bedded, sunken stalls or elevated stalls with mats, in particular rubber mats. To make lying down comfortable and to enhance good footing, some bedding may be spread on the mat. The resting areas are sized generously to provide unimpaired lying down, resting and getting up. The resting area may be subdivided into numerous lying spaces by suitable partitions between stalls. It is also known that for example a so-called double-section shed with a bedded resting area is not subdivided into stalls.

In addition to the resting areas the cowshed arrangement comprises at least one milking area where the animals are milked. A milking area is for example known from DE 37 02 465 A1 which includes an automatic milking system. The milking area is provided in a cowshed arrangement with a rectangular floor plan. The milking area is provided adjacent to one end face of the cowshed arrangement.

In addition to cowshed arrangements having a substantially rectangular floor plan, cowshed arrangements with a substantially circular floor plan are also known. Such a cowshed arrangement is described for example in U.S. Pat. No. 4,254,736, DE 102 00 254 A1 and WO 02/19807.

A circular cowshed with a center carousel milking installation is known from WO 02/19807. The carousel milking installation comprises multiple milking places where cows can be milked concurrently. The carousel milking installation is surrounded by the resting areas. Upon completion of a cowshed arrangement according to WO 02/19807 the number of the available milking places and the resting areas, and thus the capacity of the installation, is specified. The size of the herd can only be expanded within very narrow limits. If the dairy operation would wish to considerably increase the herd, it will be necessary to add another, second cowshed arrangement to the existing cowshed arrangement.

### SUMMARY OF THE INVENTION

On the basis of the above the present invention has as its objective to provide another cowshed arrangement with a circular cowshed having resting areas surrounding a center area.

The cowshed arrangement according to the invention comprises at least one milking area and at least one circular shed. The circular shed comprises a center area. A loafing area for the cattle is provided substantially concentrically surrounding the center area. The at least one milking area is located radially outwardly of the loafing area. The milking area is in particular provided to be stationary.

Due to the fact that the milking area is arranged substantially radially outwardly of the loafing area, the cowshed arrangement can be adapted to an increasing number of animals to be housed and milked in the cowshed arrangement.

For one, the size of the loafing area or the number of loafing areas may be expanded until a limit is reached for the maximum number of animals which can be milked within a given time span. In addition, the milking area may be expanded so as to achieve a higher animal throughput. The milking area is provided external of the loafing area such that as a rule an expansion of the loafing area will not affect the milking area and reversely, nor will an expansion of the milking area affect the loafing area. The milking area preferably comprises multiple milking places which are in particular also arranged stationary.

The center area may be provided to include a mechanical service room or an office e.g. on the ground floor. It is also conceivable to provide the center area with a surveillance tower from which the entire or at least substantial portions of the installation can be observed. This center area may be small or minute being e.g. only 1 m, 2 m, 3 m or a few meters in diameter.

The cowshed arrangement according to the invention allows an expansion or a reduction of the cowshed arrangement when the number of animals is reduced.

Preferably the loafing area comprises at least one resting area and preferably at least one feeding area.

One embodiment provides at least one driving device. The driving device allows the animals to be driven toward the milking area. This is highly advantageous since manual operations are thus considerably eliminated.

Preferably the driving device comprises at least one driving unit. The entire driving device—or each driving unit—can preferably travel around the circumference of the center area. It is in particular preferred that the driving unit be rotatable about a center point of symmetry or a center axis of symmetry. This will considerably facilitate driving. The driving device or individual driving units may be automatically set in motion at predefined or automatically determined times or in response to a signal to drive the animals toward the milking area unless they have already moved to the milking area voluntarily.

Preferably at least one driving unit is guided in at least one guide. Preferably at least two, three or more driving units are provided which preferably extend radially outwardly. Preferably the driving units are arranged at least in one base position at equal angular distances from one another. Preferably the driving unit comprises at least one, in particular controlled, drive unit.

It is also preferred that if multiple driving units are employed, the driving units are activated one by one at predefined time intervals. After being activated each driving unit will drive the animals within the allocated loafing area toward the milking area. It can thus be ensured that the milking area is occupied periodically or permanently.

A preferred specific embodiment provides for the milking area or at least one milking area within the circular shed to be positioned in a radially outwardly area. This has many advantages. With the milking area positioned in a radially outwardly area the driving device can rotate around the center axis of symmetry without the milking area impeding the movement of the driving device.

Given the simplest case, the driving device can always move around the center axis. At least at one angular position a retaining means is provided to mesh with the driving units to prevent animals from moving along constantly. Animals stopped by the retaining means must then walk e.g. radially outwardly (or inwardly) until they reach an exit leading to a milking area. After passing the milking area the animals will return to the loafing area. Suitable means such as section gates may be employed to prevent a turning around.

Another specific embodiment of the invention provides for the milking area to be positioned at least partially outwardly of the circular cowshed. In this case the entire milking area is preferably arranged outwardly of the circular cowshed. A connecting alley from the loafing area to the milking area will then serve to guide the animals to the milking area and another connecting alley, to lead the cattle back after checking for need to be milked and possibly after milking.

A preferred specific embodiment of the invention provides for the resting areas and/or the feeding areas to be arranged to substantially concentrically surround the center area.

Preferably the milking area comprises multiple milking places. In this case it is preferred that the milking area is formed e.g. as a side-by-side parlor, a herringbone parlor, an auto tandem parlor, a drive-through parlor, an inside access milking carousel or an outside access milking carousel, or a combination thereof.

The cowshed arrangement according to the invention is suitable in particular for dairy cattle establishments where the milking area comprises an automatic milking system, in particular a robotic milking system. An automatic milking system provides outstanding integration into the cowshed arrangement according to the invention. In an automatic milking system the milking process per se is automated. Preferably multiple automatic milking systems are concurrently employed for milking.

Specific embodiments of the invention may provide the loafing areas and the milking areas to be designed as modules such that these modules may be combined to form the desired cowshed arrangement. The modular design also provides the option of expanding existing cowshed arrangements.

Each loafing area may include one or multiple resting areas and/or one or multiple feeding areas.

Preferably one or multiple standard sizes for the cowshed arrangement are provided. It is further conceivable to reuse the platform planking elements and the planking elements forming the resting cubicle areas. The use of modular cubicles (for example of prefabricated components) is also preferred in order to provide an adaptable expansion option.

At least one feeding area may be arranged between two adjacent resting areas or surrounding a resting area with the feeding area preferably comprising an automatic feeding device. The feeding area is preferably arranged in a radially outwardly area surrounding the resting areas.

A pre-waiting enclosure in front of the milking area is preferably provided.

The animals within the cowshed arrangement are free to move about. In order to avoid that the paths of the animals terminate in dead-ends, it is proposed that the milking area have at least one through passage.

Preferably at least one walkway is provided extending in a substantially peripheral direction. Preferably the cowshed arrangement comprises at least one alley extending substantially in a radial direction and preferably connected through two walkways.

A preferred specific embodiment of the milking area comprises at least one through passage. At least in case that directed or selectively directed animal traffic is desired it is proposed that the passageway have at least one gate which opens and closes automatically. The opening or closing of the passageway may occur as a function of an animal approaching the passageway. For example animals which are not supposed to be milked more often than a predetermined number of times are allowed to simply pass through the milking system.

It is proposed that at least one identification means be provided intended for identifying individual animals. The identification means includes for example a transmitter and a receiver wherein the animal carries a mating part so as to enable identification of the animal.

Preferably at least one identification means is provided at least at one milking area or in at least one milking parlor or at least at one milking place. It is also preferred to position the identification means at least at one through passage and/or at least one selection section or selection gate.

Preferably a cowshed arrangement adaptable to changing herd sizes is achievable.

According to a further advantageous embodiment of the cowshed arrangement it is proposed that at least one selection sector be provided. The selection sector is preferably positioned adjacent to the milking area. Selection of the animals takes place in the selection sector to determine whether an animal may enter the milking area or is to be guided away from the milking area. Whether or not an animal may enter the milking area can depend on different factors. This can be for example the time elapsed since the last milking process. For example if the animal is recognized as not yet due to be milked it is guided away from the milking area through the selection sector. However, an animal recognized as due or overdue to be milked will be guided to the milking area.

The animals are free to move within the cowshed arrangement. For this purpose at least one walkway is provided extending in a peripheral direction. Depending on the manure removal method the walkway may for example be configured with slatted floors for automatic demanuring into the liquid manure channels beneath. The walkways should be dimensioned such that the animals can bypass each other without having to fear higher-ranking animals.

In order to provide to the animals room to bypass each other it is proposed to provide the cowshed arrangement with at least one alley extending substantially in a radial direction. Preferably the alley connects at least two walkways. It is in particular proposed that the alleys extend from the center area to the edge area of the cowshed arrangement.

The walkways and/or alleys may also be provided with gates. The gates open and close preferably automatically. Such opening and closing of the gates can achieve a directed animal traffic within the cowshed arrangement. Such a measure provides the advantage that the animals will be better distributed in front of the milking area.

According to a still more advantageous embodiment of the cowshed arrangement it is proposed that a feeding area be provided between two adjacent resting areas. In the feeding area a supply of the feed mixture may be offered without selection so as to eliminate the need for a particular feeding place for the individual animals. This measure allows an adaptable construction of the cowshed arrangement. Due to the fact that a feeding area is provided between two adjacent resting areas, cattle husbandry appropriate for the species can be achieved.

In addition to or instead of the feeding area between two adjacent resting areas it is proposed that a feeding area be provided near the edge of the cowshed arrangement. If the feeding area is an additional area, then for example a concentrate may be dispensed in this feeding area. Metering out the concentrate may occur in relation to performance with animal identification at the concentrate stations arranged in the feeding area. Feed is preferably metered out automatically by means of a metering feeder.

In addition to metering out feed in the feeding area, the feeding area may be equipped with livestock waterers, in particular automatic waterers, in order to meet the water requirements of the animals. The waterers should in particular be arranged to provide the animals with free access to the waterers after milking.

In particular in cowshed arrangements provided with at least one automatic milking system there is the option that the animals may go to the automatic milking system at any time. Experience has shown that a number of animals do not go to the milking parlor at all or at very long intervals so that these animals will be overdue for milking. In order to avoid this it is known that in the case of automatic milking with free animal traffic, overdue animals may be manually singled out and driven to the milking system. This procedure has its limitations in large animal herds with hundreds of animals since even just finding an overdue animal is very time-consuming for the personnel.

When automatic milking systems are employed it is therefore in particular preferred to use at least one driving device. By means of the driving device the animals are driven to the milking area and subsequently milked.

Preferably the driving device operates automatically. It is in particular proposed that the driving device drive to milking the entire cattle stock located in the cowshed arrangement two or preferably three times a day. If the cowshed arrangement has a selection sector, the animals are driven to the milking system by means of the driving device in considering the intervals between milking.

For this purpose the individual animal parameters in a herd are first established and stored. From the parameters established at least one period between milking is determined for the herd. During the period between milking one embodiment provides for the animals to not be able to go to the milking area freely such that the animals are always guided to milking at predetermined times. This measure will accustom the animals to regular milking times which will positively influence the udder health and the performance of the animals. Such a cowshed arrangement also has the advantage of a higher utilization factor of the milking system which is advantageous for economical reasons.

For the purpose of driving the animals it is proposed that the at least one milking area and the driving device are displaceable relative to one another. A particularly simple and cost-effective structure of a cowshed arrangement may be realized by having the at least one milking area configured stationary and the driving device, movable.

In order to drive the animals within the cowshed arrangement, the driving device comprises at least one driving unit which can be displaced, in particular pivoted, preferably rotated, around the center area viewed in the peripheral direction. The configuration of the driving device or the at least one driving unit is adjusted in particular to the floor plan of the cowshed arrangement and to the positions of the resting areas, the walkways and alleys.

It may be expedient to provide a waiting area in front of the milking area which preferably is a part of the selection sector. This measure will achieve better distribution of the animals within the milking area. Uneven utilization of the milking area having multiple milking places is avoided. An uneven utilization would occur when particular milking places were frequented more often than other milking places since in the radial direction the number of animals is spread unevenly.

The driving device is driven by a drive unit. Preferably this is a controllable drive unit such that the speed at which the driving device operates can be controlled. The term “controllable” also includes the option of controlling the speeds at which the driving device operates. The control variables may be the individual animal data, the milking area data, the number of animals within the cowshed arrangement and other parameters.

During the driving process the driving device moves from a home position to an end position. To return to the home position the driving device may be displaced to return wherein during the return movement preferably no driving action is performed.

A preferred specific embodiment provides that at least some milking installation rinsing times be triggered in relation to the system parameters.

To provide good conditions for animal health in the cowshed arrangement, in particular as regards foot health and good footing it is proposed to provide the cowshed arrangement with a cleaning mechanism for cleaning the resting areas and/or the alleys. The cleaning mechanism is preferably used for cleaning the resting areas. If the walkways, alleys or generally speaking the walking area for the animals have no structures suitable for automatic demanuring, the walking area is also cleaned by the cleaning mechanism. The cleaning is preferably performed by means of at least one rotating cleaning unit. The rotating cleaning unit may for example be a brush. The brush will detach any dirt and sweep it to the side.

In addition to or instead of a rotating cleaning unit the cleaning mechanism may also comprise at least one sweeper. Such a sweeper is in particular advantageous for walkways or alleys built as planar fixed walking surfaces made of concrete or poured asphalt. Planar fixed walkways must have a plane and skidproof surface. Regular sweeping will ensure that the walking surfaces are as dry and clean as possible. Polluting matter is thereby reduced and the skidproof properties increased for the safety of the animals.

A cowshed arrangement where the cleaning unit and the sweeper are arranged relative to one another such that the sweeper takes up the dirt detached by the cleaning unit is in particular advantageous. This measure will achieve an increased cleaning effect. The cleaning unit may be positioned at an angle with respect to the sweeper such that the sweeper is positioned to the side of the cleaning unit. The cleaning unit, which is preferably a rotating brush, may clean the resting area of the animals while the sweeper sweeps the walkway or walkways. The sweeper as such may comprise multiple sweeper elements, which sweeper elements are assigned to individual walkways.

For dirt removal, dirt discharge channels may be provided in the cowshed arrangement floor for the dirt to fall in and to be conveyed to disposal from there. The dirt discharge channels run preferably in the radial direction and are in particular arranged equidistant to one another. Alternatively the dirt may be discharged by means of a conveyor means. The conveyor means may operate according to the suction principle in that a suction unit is provided adjacent to the cleaning unit and/or the sweeper by means of which dirt is aspirated and discharged.

To prevent the cleaning mechanism from colliding with animals during cleaning it is proposed to have the cleaning mechanism follow behind the driving unit. The cleaning mechanism may be configured so as to travel preferably synchronously with the driving device. This is not imperative. The cleaning mechanism may also operate independently of the driving device wherein the cleaning mechanism and/or the driving device comprise sensors to ensure that when the driving device stops, the cleaning mechanism will not collide with the driving device. The sensors may for example be proximity sensors. If the proximity sensors should determine that the distance between the driving device and the cleaning mechanism falls below a minimum, the traveling speed of the cleaning mechanism may be reduced. The cleaning mechanism may also be brought to a standstill if it falls below a given preset value.

Thus the cleaning mechanism and the driving device may be moved independently of one another. It is still possible, however, to simplify the structure and reduce the controlling steps in that the driving device and the cleaning mechanism form one structural unit. Herein the cleaning mechanism is substantially rigidly coupled to the driving device such that the cleaning mechanism and the driving device comprise one common drive unit for moving the structural unit. When the cleaning mechanism and the driving device are coupled to one another the number of cleaning actions preferably corresponds to the number of driving actions. If this is not desired the cleaning mechanism may be configured for example so as to swivel about a substantially vertical axis so that the cleaning mechanism can be turned upwards.

For further simplification of the work processes within the cowshed arrangement according to the invention it is proposed to provide a bedding spreader for spreading the bedding material. The bedding spreader spreads the bedding material in particular in the resting area. Spreading of the bedding material will achieve a peaceful and clean lying down for the animals in the resting area. Furthermore, a contamination of the animals by manure on the resting surfaces is largely prevented. The bedding spreader preferably operates automatically. It is conceivable to meter the quantity of bedding per resting space correspondingly. The bedding material may be straw or wood chips. Bedding is preferably spread after cleaning is performed. For this purpose, the bedding spreader follows behind the cleaning mechanism. The cleaning mechanism and the bedding spreader may form one single structural unit.

It is in particular proposed that the bedding spreader be coupled to the driving means. Such coupling is in particular advantageous when the cleaning mechanism is also coupled with the driving means which is not imperative though.

To ensure the safety of animals and personnel as well as to increase the efficiency of operating the cowshed arrangement, it is proposed to provide a logic and/or control unit. The logic and/or control unit serves to control the mechanical work processes within the cowshed arrangement. Controlling may also include individual animal data or herd management data.

The cows may be raised and driven from the resting cubicles by the resting cubicle cleaning brush. This may occur as follows: The brush (or part of the brush) approaches the cow. As a rule, all (healthy) cows will now get up and leave the cubicle as the brush approaches. When a cow remains lying down, the brush will contact the cow which as a rule will get up at this point at the latest. After contact (measured by a sensor) the brush will return and a new attempt will follow after a preset delay. The maximum number of attempts can be pre-set. When the animal still does not leave the cubicle, the corresponding brush segment will flip to the side (or upward or the like) and move past the cow. An identification system (for example on the brush holder) will identify the cow and inform the operator by means of an entry in the error protocol and, as appropriate, through an alarm message, e-mail, SMS or the like. The stored data may be evaluated for health monitoring purposes.

According to a still further advantageous embodiment of the cowshed arrangement it is proposed that the resting areas lie on the imaginary sides of at least one polygon. This will preferably be an equilateral polygon. Thus the cowshed arrangement may for example comprise first resting areas lying on the imaginary sides for example of a first octahedron, and second resting areas on the sides of a second octahedron wherein the first octahedron and the second octahedron substantially share one common center point which is preferably in the center area. A compact structure of the cowshed arrangement can be achieved in that the resting areas are arranged substantially concentrically surrounding the center area.

According to a still more advantageous embodiment of the cowshed arrangement it is proposed that at least the resting areas be arranged on at least two levels. For a cost-effective configuration of the cowshed arrangement it is proposed that it comprise a tent-shaped roof.

According to another configuration the center area serves to receive at least one milking area. It is surrounded by the resting areas. A driving device is suitable for driving the animals toward the center milking area. Preferably the driving device is provided to be rotatable. Specific embodiments include one or all of the features of the configurations described above. The applicant reserves the right to file separate applications for such devices.

According to a further inventive idea, a cowshed installation is proposed comprising at least two cowshed arrangements which cowshed arrangements may be arranged in a honeycomb layout.

Preferably two, three, or more cowshed arrangements comprise one common milking area. It is in particular proposed that at least two cowshed arrangements comprise one common milk house. At least one bulk milk tank is located in the milk house where the milk from the milking areas is collected and stored.

In all of the specific embodiments described above it is conceivable that a subway is provided. Through the subway the individual milking places can be reached from underneath without crossing the path of the animals or otherwise impairing them. The subway may receive technical equipment. Said subway may in particular receive e.g. all the noisy appliances. Instead of a subway a bridge may be provided.

A tower may be provided in the center area from which the installation and the entire cowshed can be observed. A central or decentralized control may also be provided there.

When the shed is to be cleaned thoroughly (for example when there are no animals inside), the driving unit may be provided with a spray system to soak the cowshed floor for example at 2-hour intervals.

Preferably “normal” cleaning during operation will provide only dry cleaning wherein the cleaning brushes may be self-cleaning or they may be cleaned in a cleaning brush cleaning mechanism.

In the case of multiple round cowsheds or cowshed arrangements a central bulk milk tank may be provided (or also a [feed] supply center).

Other advantages and details of the invention will be explained on hand of the embodiments illustrated in the drawing wherein the object of the invention is not intended to be limited to the specific embodiments;

### BRIEF DESCRIPTION OF THE DRAWINGS

FIG. 1 is an embodiment of a cowshed arrangement in a top view.

### DETAILED DESCRIPTION OF THE PREFERRED EMBODIMENT

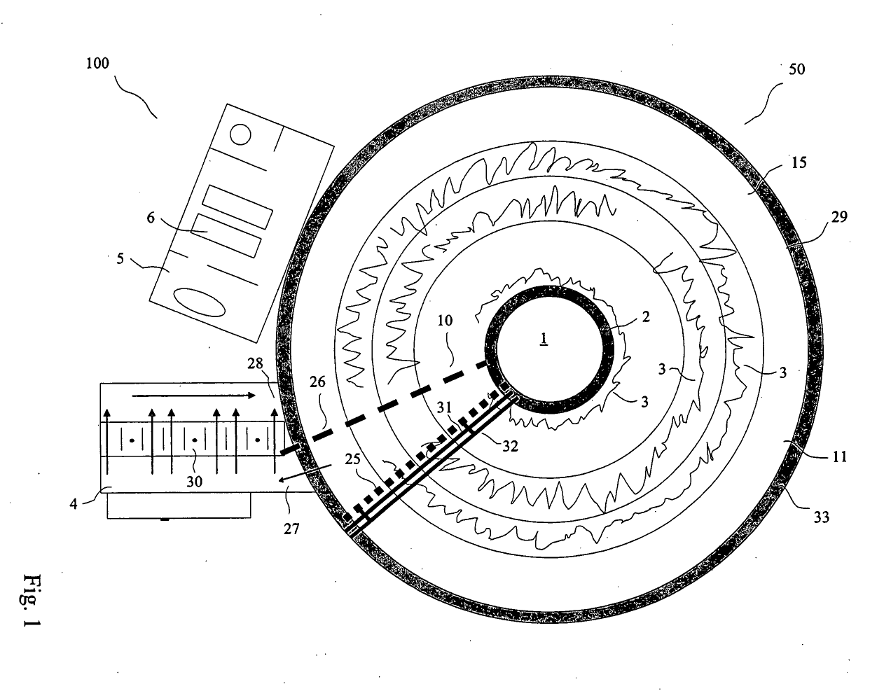

FIG. 1 shows a schematic top view of a first embodiment of a cowshed arrangement 100. The cowshed arrangement 100 illustrated in FIG. 1 has a circular floor plan. It comprises a circular cowshed 50 and a center area 1.

This center area 1 may be structured as a tower. It may be a multi-story tower. The individual stories may be provided for different functions. For example the lower portion of the tower may receive technical equipment. The technical equipment may be logic and control units, data processing systems, supply lines as well as other technical means required for operating the cowshed arrangement or which are accessories necessary or useful for operating the cowshed arrangement.

The tower is accessible through a subway one end of which is outwardly of the cowshed arrangement. In another story of the tower for example an office or a monitoring center may be installed. For this purpose it is advantageous that the tower be designed so as to provide an operator with a free view preferably over the entire cowshed arrangement. For this purpose the tower may be equipped with glass walls. An inspection gallery 2 is provided to surround the center area 1 or the tower.

The cowshed arrangement comprises resting areas 3. The resting areas 3 are arranged to surround the center area 1. The resting areas 3 are arranged concentric around the center area 1. The resting areas may be configured as bedded, sunken stalls or elevated stalls with mats, optionally with some bedding spread on the mat for lying comfort and to provide good footing. To provide unimpaired lying down, resting and getting up, the cubicles in the resting areas are sized generously and subdivided as suitable for the animals. The separation may be done with gates. This is not imperative. The resting areas 3 may be configured without separation into stalls which will considerably facilitate automatic cleaning of the cowshed arrangement.

For milking the animals located in the cowshed arrangement, a milking area 4 is provided which extends radially outwardly of the loafing area 29. In the illustrated embodiment the milking area is provided outwardly of the circular shed 50 and connected to the circular shed 50 through an entrance 27 and an exit 28. A connection may be provided through alleys running the distance between the milking area 4 and the circular cowshed 50. Another embodiment may provide multiple, e.g. two, three, or four circular cowsheds 50 arranged relative to one another in a suitable, preferably substantially symmetric, geometry. In the center of the circular sheds 50 a milking area 4 may be provided which serves as a center milking area for particular or all of the circular sheds.

In the embodiment shown in FIG. 1 the milking area 4 comprises three twin parlor installations equipped with an automatic milking system each. The automatic milking systems each comprise a robot arm for placing the teat cups. In this case, drive-through parlors are employed. Other single- or multiple parlor systems can also be employed, such as a milking robot in an auto-tandem parlor. The milking area may be equipped with a conventional milking installation such as a herringbone parlor or in particular a milking carousel.

In order to collect the milk yield it is conveyed through a piping system, which is not shown, into a milk house 5. The milk house 5 comprises bulk tanks, in particular cooling tanks 6. The piping system which is not shown opens into the cooling tanks so as to convey the milk yield into it. An outlet into the subway 6 may be located in the milk house. The piping system leading from the milking area to the tanks in particular to the cooling tanks 6 is preferably located in the subway which is not shown.

The milking area 4 may be provided with passages, which are not shown, so that the animals may pass through the milking area 4 without being milked.

The entry area of the milking area 4 may be provided with a selection sector which serves to separate animals determined as due to be milked or not due to be milked. Forming a selection sector is not imperative. A selection gate may be provided at the exit 28 in particular for guiding animals that are e.g. conspicuous or have been identified as sick, toward a separating area (not shown). There the farmer can visually inspect the animals and if appropriate have them checked by a veterinarian.

To allow the animals to move about freely, walkways are provided within the cowshed arrangement 100. The walkways are configured concentric to the center area 1. The width of the walkways is sized such that the animals can bypass one another without fear of higher-ranking animals. In order to further enhance free movement of the animals as well as to simplify the configuration of the cowshed arrangement, alleys are provided. The alleys preferably extend in a radial direction wherein the alleys may connect the walkways with one another. Preferably one alley is provided for every twelve to fifteen resting stalls or resting spaces. Due to this measure the animals are given room to bypass one another.

The cowshed arrangement 100 shown in FIG. 1 comprises a driving device 10. The driving device 10 in the illustrated embodiment rotates clockwise in top view around the center area 1. The driving device 10 extends from the center area 1 to an edge area 11 of the circular cowshed 50.

The subway configured so as to extend radially outwardly from the center area 1 preferably runs below the barrier in the form of a barrier grid 25 which meshes with the driving arm 26 of the driving device 10.

The driving device 10 is activated dependent on the pre-set speed. Preferably the driving device passes across the circular cowshed or the cowshed arrangement once every two, four, eight, or twelve hours. The speed at which the driving device travels across the cowshed can be controlled or regulated. The driving device 10 and the milking area 4 are configured such that the driving device passes through the barrier gate 15, e.g. meshing. This configuration is particularly readily realized.

Specific configurations include a driving device 10 formed such that the animals located radially inwardly are driven outwardly in that a meshing engagement of the driving device 10 with the barrier gate 25 will first occur radially inwardly and only thereafter outwardly, with progressing radial movement. This may be achieved by a driving device extending in a radial direction, not straight but inclined relative thereto. A driving device extending e.g. straight and slightly touching the center area 1 tangentially will fulfill this criterion if the radially outwardly area follows behind. A sickle-shaped configuration is also conceivable.

The driving device 10 may comprise more than one driving unit configured as a driving arm 26. They are arranged in a base position preferably at equal angular distances from one another. The particular driving arms 26 may be rotatable independently from one another.

It is also conceivable that the driving device does not mesh with and pass through the barrier gate 25 but that it is guided to pass above the barrier gate 25. The driving device may comprise a guide extending preferably over the entire traveling path of the driving device.

As the driving device has completed one circle, all of the cows will have been guided through the milking area 4 and been milked as required. Depending on the position of the driving device, individual or multiple process steps may be triggered in the milking area, in particular in an automated milking system. Thus for example the driving device may activate rinsing of the milking system depending on its position. During rinsing the driving device will for example sweep across the milking area and begin a new cycle behind the milking area.

To clean the walkways, alleys and/or the resting areas, a cleaning mechanism 31 is preferably provided.

At least one feeding area is provided for feeding the animals in the edge area 11. It is expedient to provide the animals with the option of water intake adjacent to the milking area 4 such that after milking the animals can reach a waterer without having to walk long distances.

Cows are very adaptable as regards ambience temperature. They are less sensitive to sub-zero temperatures than to high summer temperatures. Thus they are well housed in uninsulated buildings with a large air volume. A roof to keep the rain out and provide shade, and wall structures to provide wind protection are sufficient. In the illustrated embodiment of the cowshed arrangement it has a tent-shaped roof 15 extending to also cover a feed table 33 provided in the edge area.

Preferably the cowshed arrangement comprises at least one identification means intended for identifying individual animals. By means of the identification means animals which are being milked can be recognized. There is also the option that animals which are not supposed to be milked for a predetermined number of times within a specific period may be guided through the milking area without being milked. The configuration of the cowshed arrangement according to the invention provides the option to expand the cowshed arrangement by adding resting areas and/or milking areas so as to provide a cowshed arrangement which is suitable for a larger number of animals.

The cowshed arrangement according to the invention is not limited to cowshed arrangements which are precisely circular in basic structure. There is also the option to configure cowshed arrangements with sheds which may substantially be called round. For example a regular hexagon or a regular octagon. These arrangements may also provide a rotatable driver and/or a rotatable cleaning mechanism 31 and/or a rotatable bedding spreader 32.

The animals which are located within the cowshed arrangement can move along the walkways and the alleys. By means of the driving device the animals are driven to the milking area 4 preferably periodically.

The invention allows to combine free and directed animal traffic. The animals are free to move within the loafing area but they are preferably driven to be milked. This will allow that an automated milking installation will always be optimally utilized while with a conventional milking installation the milking times may be optimized in view of duration and throughput.

1. A cowshed arrangement comprising at least one milking area, and at least one circular cowshed having a center area and a substantially concentric, surrounding loafing area, and wherein at least one milking area is arranged radially outwardly of the loafing area.

2. The cowshed arrangement according to claim 1, and further comprising a driving device.

3. The cowshed arrangement according to claim 2, wherein the driving device comprises at least one driving unit which is displaceable around the center area.

4. The cowshed arrangement according to claim 1, wherein the milking area is located within the circular cowshed in a radially outwardly area.

5. The cowshed arrangement according to claim 1, wherein at least part of the milking area is located outwardly of the circular cowshed.

6. The cowshed arrangement according to claim 1, wherein the loafing area comprises at least one resting area.

7. The cowshed arrangement according to claim 6, characterized in that the resting areas is arranged substantially concentrically around the center area.

8. The cowshed arrangement according to claim 1, wherein the milking area comprises multiple milking places.

9. The cowshed arrangement according to claim 1, wherein the milking area is configured as a parlor taken from the group of parlors consisting of: a side-by-side parlor, a herringbone parlor, an auto tandem parlor, a drive-through parlor, an inside access milking carousel, and an outside access milking carousel, and combinations thereof.

10. The cowshed arrangement according to claim 1, wherein the milking area comprises at least one automated milking system.

11. The cowshed arrangement according to claim 1, wherein the milking area comprises at least one through passage having at least one gate which opens and closes automatically.

12. The cowshed arrangement according to claim 1, and further comprising at least one selection sector.

13. The cowshed arrangement according to claim 1, and further comprising at least one animal identifier.

14. The cowshed arrangement according to claim 1, wherein the circular cowshed comprises at least one walkway extending substantially in the peripheral direction.

15. The cowshed arrangement according to claim 1, wherein the circular cowshed comprises at least one alley extending substantially in a radial direction.

16. The cowshed arrangement according to claim 1, and further comprising at least one feeding area between two adjacent resting areas and an automated feed metering device.

17. The cowshed arrangement according to claim 1, and further comprising a pre-waiting enclosure in front of the milking area.

18. The cowshed arrangement according to claim 1, and further comprising an automated cleaning mechanism.

19. The cowshed arrangement according to claim 18, wherein the cleaning mechanism comprises at least one rotating cleaning unit.

20. The cowshed arrangement according to claim 19 and further comprising a sweeper, wherein the rotating cleaning unit and the sweeper is arranged relative to one another such that the sweeper will take up the dirt detached by the cleaning unit.

21. The cowshed arrangement according to claim 18, wherein the cleaning mechanism and a driving device form one structural unit.

22. The cowshed arrangement according to claim 1, and further comprising an automated bedding spreader.

23. The cowshed arrangement according to claim 22, wherein the bedding spreader is coupled to a driving device.

24. The cowshed arrangement according to claim 1, and further comprising a logic unit.

25. The cowshed arrangement according to claim 1, wherein the cowshed comprises a tent-shaped roof.

26. The cowshed installation according to claim 1 and further comprising at least two circular cowsheds, wherein the circular cowsheds share at least one common milking area.

27. The cowshed installation according to claim 26, and further comprising a common milk house.
